(19) United States
(12) Patent Application Publication
(10) Pub. No.: US 2015/0102022 A1
(43) Pub. Date: Apr. 16, 2015

(54) Laser Scoring to Control Gas-Vapor Transmission in Sealed Packaging

(71) Applicants: Kyle Crable, Vadnais Heights, MN (US); Juan Carlos Tinoco, Vadnais Heights, MN (US); Gregory Jahr, Vadnais Heights, MN (US)

(72) Inventors: Kyle Crable, Vadnais Heights, MN (US); Juan Carlos Tinoco, Vadnais Heights, MN (US); Gregory Jahr, Vadnais Heights, MN (US)

(73) Assignee: LASERSHARP FLEXPAK SERVICES, LLC, Vadnais Heights, MN (US)

(21) Appl. No.: 14/055,635

(22) Filed: Oct. 16, 2013

(51) Int. Cl. B23K 26/00; B23K 26/36

(52) U.S. Cl. CPC B23K 26/0021; B23K 26/365
USPC 219/121.68

(57) ABSTRACT

An adjustable system for controlling an amount of gas permeability allowed through multilayer material. A laser is controlled through a controller, and the laser processes the multiple layer material to remove only some of the layers in only an area. The area can be a pattern such as a line, or can just be a pattern of areas. The layers are removed without fully penetrating the material, thus adjusting the gas permeability. This allows gases and vapors to transmit into the package thru the scored area more specifically thru the remaining material at a faster rate than a non-scored material. The pattern can score along a line to allow gases and vapors to pass through more rapidly. The laser beam does not cut through the entire structure, and the package remains sealed. This means, therefore, that the amount of gas/vapor permeability can be changed for a sealed package, e.g., with material therein.

This application claims priority from provisional application No. 61/714,527, filed Oct. 16, 2012, the entire contents of which are herewith incorporated by reference.

### BACKGROUND

Many different kinds of packaging materials are known.

Breathable films on the market for modified-atmosphere-packaging applications, such as perishable food products or fresh produce (e.g. fresh fruit, lettuce, seafood) typically use mechanical methods, such as needles or dies to punch through the entire packaging material. This results in a package that allows the gas and water vapor to be exchanged but leaves the package prone to unwanted contamination from the outside environment.

In recent years, companies have been developing ways to optimize sealed packages for a longer shelf life of perishable food products by achieving specific oxygen transmission rates (OTR). To prevent the growth of aerobic spoilage microorganisms, as well as decrease the rate of oxidative deterioration of perishable food products; oxygen levels must be kept at specific levels. Film suppliers have accomplished this by developing new special films capable of achieving a range of OTR values. These special films are currently in the market at very high prices and are only capable of achieving broad range OTR values making them unreliable and difficult to duplicate with precision and accuracy.

The special films are designed to target a range of OTR values. Hence, different types of film are needed for each different product type to be packed, e.g. a different kind of perishable food product. A new film may be needed if the special film does not achieve an exact OTR value or a value close to the respiration rate of the product to be packed. A new film may also be needed if the type of product to be packed is changed, the quantity of product within the package changes, or the package size or design changes, etc. Changing new films becomes costly and highly inefficient.

### SUMMARY

The present application describes a laser scoring process used to precisely modify the gas and vapor transmission rate of a packaging material to a desired value while maintaining a sealed package.

Embodiments use laser technology to score packaging material to adjust the gas and vapor transmission rate for a modified-atmosphere-package.

Laser scoring as done according to embodiments can remove material from one or multiple layers of the material structure without fully penetrating the material. The laser scoring process is implemented by creating a pattern and/or shape to remove specific layers and/or target thickness of the material. This allows gases and vapors to transmit into the package thru the scored area at a faster rate than a non-scored material. The laser beam does not cut through the entire structure, and the package remains sealed. This means, therefore, that the amount of gas/vapor permeability can be changed for a sealed package, e.g., with material therein.

This feature can be used to prevent both the growth of spoilage microorganisms and oxidative deterioration rate of perishable food products inside the package. Moreover, this allows changing the amount of permeability, e.g., for different climates or needs.

An aspect generally relates to the use of laser technology to precisely adjust the gas and vapor transmission rate in a packaging material by scoring or removing a controlled amount of material.

The invention of the laser scoring process can be performed using any pattern(s) and/or shape(s) using the desired gas and vapor transmission rate.

Embodiments use the modification of gas and vapor transmission rates for any packaging materials or types used in a wide variety of markets, such as food, medical, pharmaceutical, health care, etc.

Embodiments allow the precision of a laser to accurately score a pattern(s) and/or shape(s) used to remove thin layer(s) of a given packaging material to modify the amount of gases and vapors that transmit into the package.

Embodiments allow packages to keep their sealed properties while allowing specific amount of gases and vapors from the atmosphere to transmit into the package at the desired rate.

### BRIEF DESCRIPTION OF THE DRAWINGS

FIG. 1 is a diagram of a system that is used to form a pattern on a moving web of material, where the pattern can be adjusted to set the desired gas and vapor transmission rate;

FIG. 2 shows a system forming perforations on a packaging material;

FIG. 3 shows top views and cross section of perforated packages;

FIGS. 4A-4I show different laser scored patterns;

FIGS. 5A-5I show various cross sections of processed materials.

### DETAILED DESCRIPTION

In response to the issues described above, the inventors have disclosed embodiments for a laser perforation process that penetrates partially thru the material or make “blind” perforations. This method has been proven successfully for low OTR requirements; therefore, the small breathable area exposed at each micro perforation is enough to guarantee small OTR values. However, when a higher OTR value is required, this method can be inefficient because of the large amount or density of perforations or breathable area needed.

The inventors found the value of laser scoring patterns or shapes on the film to achieve low or higher OTR values is due to the laser score pattern exposing a larger breathable area, with a controlled score depth into the material or removal of specific layers of the material. This enhances the gas transmission or respiration rates of the package without compromising structural integrity or direct exposure to the outside environment. The laser score process is capable of scoring various materials to a controlled depth and pattern to provide precise, accurate, and consistent gas and vapor transmission values with minimum variability. The flexibility of this invention allows for quick change of laser scoring pattern(s) and/or shape(s) designed to fit any package size and respiration rates at higher production rates when compared to drilling or perforating blind holes. The depth of the laser score pattern can also be automatically adjusted in response to variations in material thickness. Based on the testing results and application, one can perform multiple laser scores of the same or any variation of the pattern(s) or shape(s) to achieve the specified gas and vapor transmission value. Laser scoring is a non-contact material removal process, differentiating from the mechanical tooling method of scoring or perforating where the tool may come into contact with the film. Tool contact can contaminate the package or create features that are not controlled. Laser scoring provides the ability and flexibility to modify the gas and vapor transmission value of standard packaging materials by instantaneously changing the laser score pattern or depth or number of laser score features. The ability of making these modifications to the material in an inline process gives the laser scoring process a large advantage over specialty films and mechanical tooling. The invention can be done using the same starting film to accommodate a variety of products having different OTR needs.

Laser scoring as done according to embodiments can remove material from one or multiple layers of the material structure without fully penetrating the material. Scoring (sometimes described as etching, engraving, scribing, marking) or partially cutting through a packaging material using any technique, with the intention of modifying the inside atmosphere of the package or modifying the transmission rate of any gases and vapors, such as Oxygen, Nitrogen, Water Vapor, etc. from the outside atmosphere. Undesirable gases such as ethylene present in some perishable food products can also escape from the package through the laser scored packaging film.

The laser scoring process is implemented by creating a pattern and/or shape to remove specific layers and/or target thickness of the material. The laser technology is to create score patterns or blind perforations to modify the transmission rate of gases and vapors within the package. The use of laser scribing not only allows for a precise and repeatable scoring or blind perforation process, as described herein. The process is superior to mechanical scoring or perforating as described herein.

Through the removal of one or more layers of material or to a controlled depth into the material, it is possible to increase the transmission rate of gases and vapors within the package without compromising its other sealed properties.

The laser scored and/or blind perforation pattern is not limited to any particular size or shape, and can be, for example, any of the shapes described herein.

The material can include a mono layer polymer, multi-layer polymer, or multi-laminated film structures or structures that use other materials, such as metal foils or paper. The material can be printed or unprinted.

The material can be any thickness and embodiments can automatically adjust for varying material thickness using the techniques described herein. The laser score and/or blind perforation depth can be adjusted based on the properties of material.

Any of the currently available transmission rate sensors or test equipment can be used to measure the OTR of the scored material.

The material can be laser scored and/or blind perforated from the top, bottom, or both surfaces.

The material can be laser scored and/or blind perforated with overlapping patterns.

The material can be laser scored and/or blind perforated in registration with printed marks on the material or at a fixed or random spacing without registration marks. As used herein, blind perforation refers to a partial perforation or penetration thru the film by the laser beam, meaning the laser beam does not cut the material completely, instead it is controlled to cut to certain depth or layers within the film structure.

The package can be laser scored and blind perforated at any step of the manufacturing process (e.g. prior to lamination, slitting, in line with packaging, after packaging, etc.) to modify the gas and vapor transmission rates of the package.

The laser scoring and/or blind perforation can be used to modify the gas and vapor transmission rate on any package type and size.

The laser scored and blind perforated pattern and/or shape can be processed continuously, randomly, fix repeat, and/or register to the print by using vision system or photo eye sensor.

The laser scored and blind perforated pattern and/or shape can be processed in both the cross web and machine direction.

The operation proceeds as described herein.

An embodiment describes the operation using and referencing oxygen for the calculations. However, the same techniques in the same equations can be done to determine and to change the operation for any type of gases and vapors.

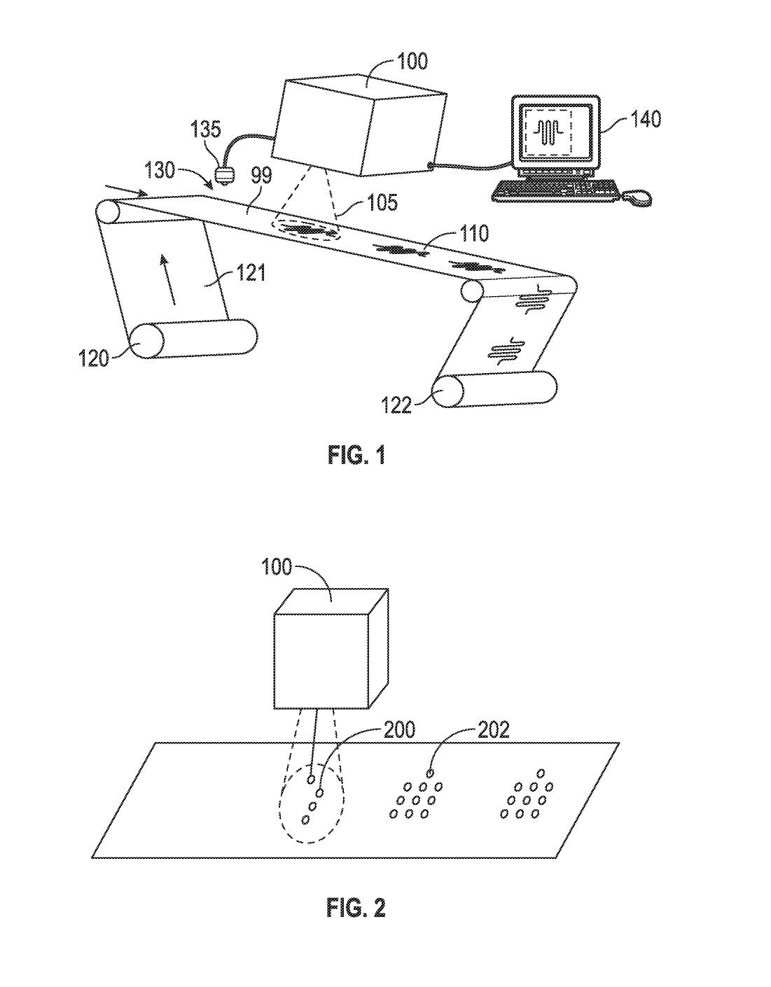

The operation is described with reference to FIG. 1. In this embodiment, the parameter initially specified is the desired oxygen transmission rate or OTR that will satisfy the respiration rates of the product to be packed. Oxygen transmission rate is generally known as a measure of the amount of oxygen that passes through a substance. OTR thereby refers to the permeability of packaging.

The total OTR of a packaged product, can be calculated from equation 1:

$${OTR}_{T} = [ \frac{M \times \dot{R}}{{A}_{s} \times P \times ( Atm {O}_{2} - Int {O}_{2} )} ] \times \frac{24 hr}{day} \qquad ( 1 )$$

where, M is the mass of the product (kg), is the respiration rate (cc O₂ hr/kg) at anticipated storage temperature. As is the breathable surface area of the package (m²), P is the atmospheric pressure (1 atm), AtmO₂ is the volume fraction of O₂ in ambient air (21% O₂), and IntO₂ is the desired O₂ atmosphere inside the package stated as volume fraction.

The base OTR of the material used multiplied by the breathable surface area gives a measurement of the oxygen flow through the surface area of the package per day as seen in equation 2.

Flux_{O}_{₂}_{Film}=OTR_{base-film}×Aₛ (2)

The same relation for the oxygen flow is used to find the total oxygen flow through the surface area of the package as seen in equation 3.

Flux_{O}_{₂}_{Total}=OTR_{T}×Aₛ (3)

Based on the assumption that the total oxygen flow will be higher than the material base oxygen flow, the scored and/or blind perforation oxygen flow is equal to the total oxygen flow minus the oxygen flow through the respiration area as seen in equation 4.

Flux_{O}_{₂}_{PerforationScoreLaser Process}=Flux_{O}_{₂}_{Total}−Flux_{O}_{₂}_{Film} (4)

The calculated value for the scored and/or blind perforation oxygen flow works as a theoretical benchmark for the experimental trials that are later performed to obtain a value for the oxygen flow of one laser scored and/or blind perforation pattern to estimate how many scores and/or blind perforations are needed to achieve the specified OTR.

The surface is then laser scored using the system shown in FIG. 1. In FIG. 1, a laser scoring system 100 produces a laser output 105 on the material 99 as the material passes. The laser scoring creates a laser scored pattern 110 of a specified pattern. In this embodiment, the material 99 passes from a supply roll 120 in the direction 121 towards a take-up roll 122. The material may have eye marks such as 130 thereon which are sensed by a photosensor 135. The laser system 100 is controlled by a computer or laser controller 140 to produce outputs having specified levels to create the desired pattern.

For unprinted material with no registration marks, the laser controller 140 can be configured to laser score and/or blind perforate at a fixed or random distance. To ensure the laser score and/or blind perforation meets the quality and specifications, a microscope analysis and OTR testing of the laser processed material can be performed. If required by the job specifics, a tensile analysis may be performed on the laser processed area of the material. The microscope analysis can include analysis of the top and cross-section views of the material laser scored and/or blind perforated section.

In one embodiment, the material surface to be laser processed should be flat and facing up towards the laser. A designated score pattern will be created and transferred into the laser controller. Depending on the value specified for the oxygen flux, one or more patterns or shapes cam be laser scored and/or blind perforated on the film to reach the total oxygen transmission rate needed for the product. Initial conditions of the laser system can be established upon job and material specifics.

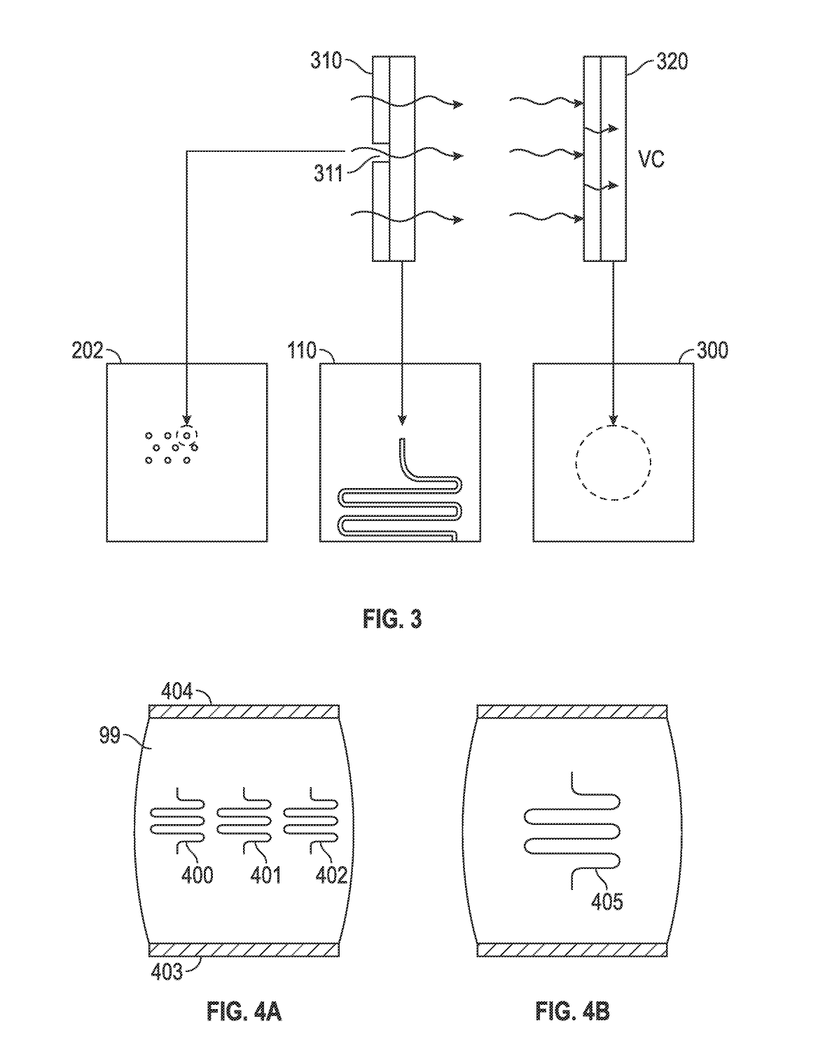

A first pattern 110 is shown in FIG. 1. Alternative patterns can alternatively been created. For example, FIG. 2 shows the laser system 100 creating an alternative type of pattern 200, 202 at specified shapes. Again, the laser can process the film from the top, bottom, or from both directions.

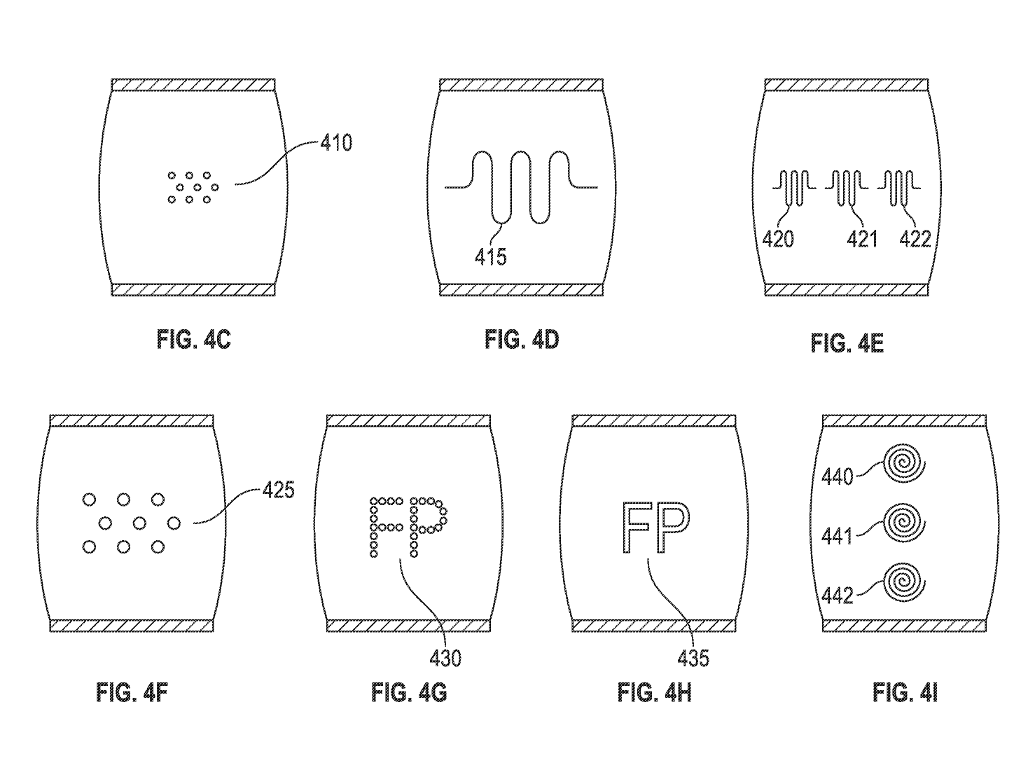

FIG. 3 shows the different patterns, 110 and 202, and also 300 shows a non-scored material. The top part of FIG. 3 shows how the oxygen will pass through these laser scored materials as compared with an unprocessed material. The laser partial or blind perforation of 202 and the laser scored pattern 110 has a cross-section generally shown as 310 in FIG. 3. In this cross-section, there is a 3 layer lamination, where openings such as 311 are formed by the perforation. Oxygen preferably passes through these openings. The cross section 320 shows small amounts of oxygen passing through the non-scored material.

FIG. 3 illustrates the top and cross sectional views used to illustrate the quality and correctness of the laser score and/or blind perforation. The depth and width of the laser score and/or blind perforation can be measured from the cross-sectional view. From the top view it is possible to make an assessment of the quality of the laser processed area, as well as any changes needed to precisely control the amount of material removed from the packaging material. The OTR testing can be performed using the steady or unsteady known methods. To have a good approximation of the OTR value, three samples of the same variable are usually tested and a value is recorded from result of their averages.

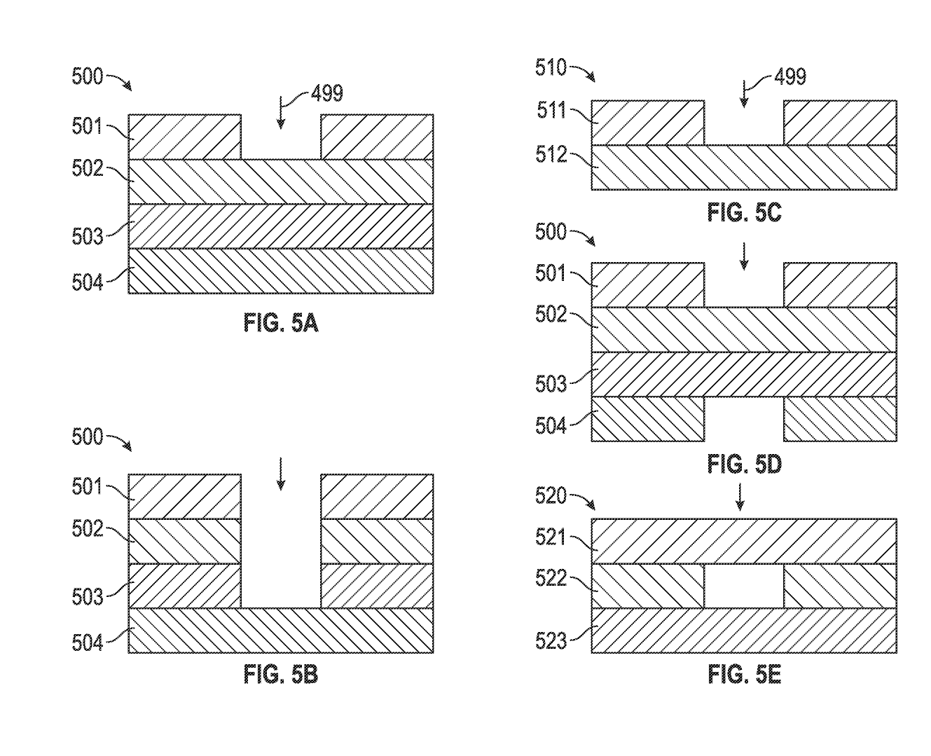

FIGS. 4 A-4 I show different scoring patterns that can be used to score the material. These materials may be the webs of material shown is 99 in FIG. 1, where laser scored patterns can be processed in both the machine direction and/or the cross web direction. Different combinations of laser scored patterns can be used to obtain the desired oxygen transmission rate.

For example, in FIG. 4A, there are 3 laser scored patterns 400, 401, 402 that are formed in the package to achieve the desired OTR. This material is then sealed at the bottom 403 and at the top 404 to form the package and may also be sealed on the side. By scoring in the shape of the pattern, this opens a much larger area, than would be formed by the multiple holes. The pattern can be a spiral shape as shown as 400, or can be in any other line or shape or pattern. The laser is dragged across the surface in the shape 400, thus scoring this line/pattern as compared with scoring holes.

FIG. 4 B shows a single laser scored pattern 405 in the package.

FIG. 4C shows a pattern of blind perforations 410 of small size carried out in the package.

FIG. 4 D shows a larger size laser scored pattern 415 formed across the package, where the pattern is a contoured score. FIG. 4E shows 3 laser scored patterns 420, 421, 422 that are of reduced size and are formed within the package.

FIG. 4 F shows blind perforations 425 of a larger size spread out in the middle of the package.

FIG. 4 G shows blind perforations in a specified pattern 430. Any of these patterns or any other pattern can be used according to this system.

FIG. 4 H shows a laser score in a specified pattern 435. Any of these patterns or any other pattern can be used according to this invention.

FIG. 4I shows 3 laser scored spiral patterns 440, 441, 442 that are of any size and formed within the package.

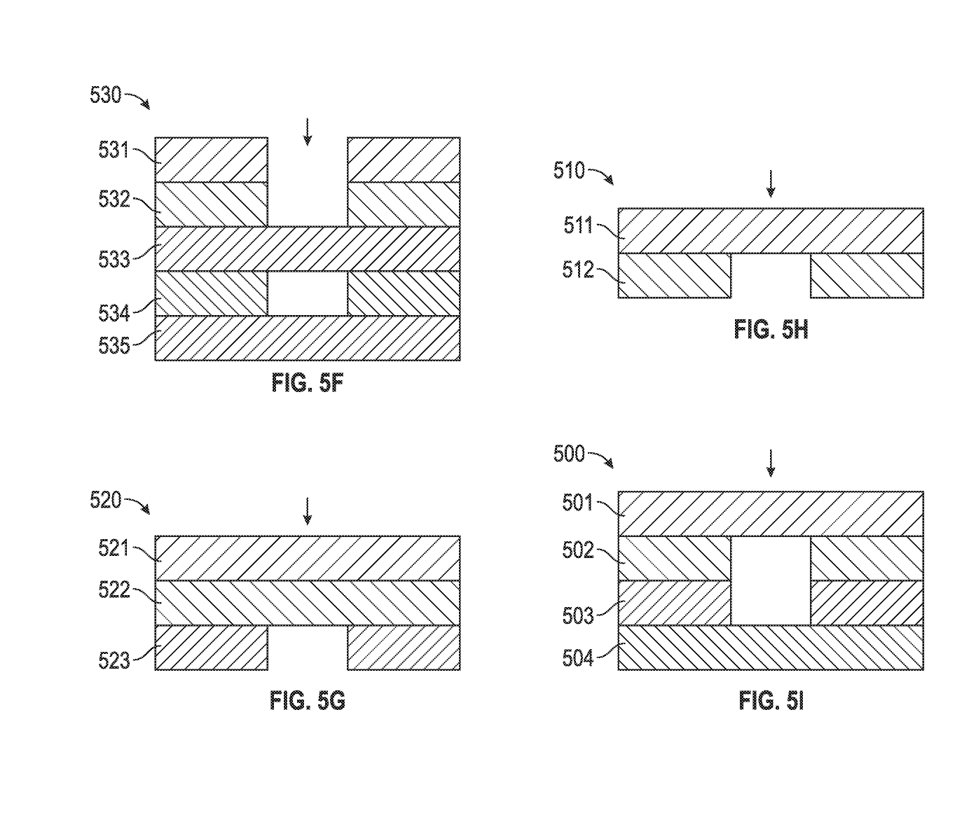

The film structures can have different characteristics based on the way in which the laser perforate the material and also based on the number of layers making up the material. For example, the material may be any number of layers of film of the embodiment shown in FIG. 5 A-5I.

FIGS. 5A-5I show cross-section images that illustrate the effect of the laser score and/or blind perforation in multiple material structures and film laminations.

FIG. 5A shows a 4 layer film structure 500 and shows how the laser beam 499 penetrates only one layer 501 of the 5 layer structure, so the other layers 502, 503 and 504 are not penetrated by the laser beam.

FIG. 5B, on the other hand, shows the same 5 layer structure 500, but shows that layers 501, 502, 503 are all penetrated, and layer 504 remains intact.

FIG. 5C shows a 2 layer film structure 510 where only the first layer 511 is penetrated, and layer 512 stays intact. Note that the laser beam 499 is applied from the top of this film structure, to perforate the top layer 511.

FIG. 5H also shows the 2 layer film structure 510 but shows the laser beam 499 is applied from the top of this film structure; however, it only penetrates the bottom most layer 512 without affecting the top layer 511. In this case layer 511 has transmissive characteristics to the laser, meaning the laser beam can travel through the layer without cutting it.

FIG. 5 D shows a four layer structure 500, where the laser beam 499 is applied from the top of this film structure but only penetrates the top layer 501 and the bottom layer 504 with the two middle layers 502, 503 remaining intact.

FIG. 5I shows the opposite scenario, where the 2 internal layers 502, 503 are scribed by the laser beam, but the top layer 500 and the bottom layer 504 remain intact.

FIGS. 5E and 5G shows a 3 layer structure 520. In the FIG. 5G structure, the bottommost layer 523 is cut by the laser, while the 2 top layers 521 and 522 remain intact.

In the FIG. 5G structure, only the center layer 522 is scribed, while the top and bottom layers 521 and 523 remain intact.

FIG. 5 F shows a 5 layer structure.

While this can be processed in the way previously described, to remove any of the layers, a particularly advantageous lasing is shown where the material 530 has its top 2 layers 531 and 532 removed, the third layer 533 is transmissive to the laser bean and remains intact, the fourth layer 534 removed, and the laser stops penetrating after so the fifth layer of film 535 is intact.

The various illustrative logical blocks, modules, and circuits described in connection with the embodiments disclosed herein, may be implemented or performed with or running a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form. This may include laptop or desktop computers, and may also include portable computers, including cell phones, tablets such as the IPAD™, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for laser scoring a material, comprising a laser and a controller, said laser controlled to process a multi-layer web of material and to remove material from at least one layer of the multi layer material without fully penetrating the material, said controller defining a pattern on which the material is processed to remove the at least one layer,
said controller operating to create a processed material which is sealed but which has a specified gas/vapor permeability.

2. The system as in claim 1, wherein the pattern comprises a line in a spiral shape.

3. The system as in claim 1, wherein the pattern comprises a line of a defined shape and path.

4. The system as in claim 1, wherein the material has multiple layers, and at least one of said multiple layers is removed at areas of said pattern.

5. The system as in claim 4, wherein at least one layer at a top portion of the material is removed along said pattern, said top portion being adapted to be exposed to the environment.

6. The system as in claim 4, wherein at least one layer at a bottom portion of the material is removed along said pattern, where at least one layer at a top portion, between said bottom portion and the environment, remains intact.

7. The system as in claim 1, wherein said material has at least 3 layers.

8. The system as in claim 1, wherein said material has at least 4 layers.

9. The system as in claim 1, wherein said material has multiple layers, and one layer is removed between two other layers along said pattern, leaving a removed layer between said two layers which remain intact.

10. A system for forming an adjustable gas permeable material, comprising:
a laser device, configured to remove layers from a multiple layer material; and
a controller, said controller controlling said laser to remove some but not all of the layers from the multiple layer material in only an area of the multiple layer material, according to a desired amount of gas permeability, where said area is defined by a pattern.

11. The system as in claim 10, where said controller stores a shape of the pattern.

12. The system as in claim 11, wherein the pattern comprises a line in a spiral shape.

13. The system as in claim 11, wherein the pattern comprises a line of a defined shape and path.

14. The system as in claim 11, wherein the material has multiple layers, and at least one of said multiple layers is removed at areas of said pattern.

15. The system as in claim 14, wherein at least one layer at a top portion of the material is removed along said pattern, said top portion being adapted to be exposed to the environment.

16. The system as in claim 4, wherein at least one layer at a bottom portion of the material is removed along said pattern, where at least one layer at a top portion, between said bottom portion and the environment, remains intact.

17. The system as in claim 14, wherein said material has at least 3 layers.

18. The system as in claim 14, wherein said material has at least 4 layers.

19. The system as in claim 11, wherein said material has multiple layers, and one layer is removed between two other layers along said pattern, leaving a removed layer between said two layers which remain intact.
